(19) United States
(12) Patent Application Publication
(10) Pub. No.: US 2008/0043204 A1
(43) Pub. Date: Feb. 21, 2008

(54) Digital scent movie projector with sound channel

(76) Inventor: Yixin Guo, Ronkonkoma, NY (US)

Correspondence Address: Yixin Guo, 256 Holbrook Ave, Ronkonkoma, NY, 11779, US

(21) Appl. No.: 11/588,154

(22) Filed: Oct. 27, 2006

(30) Foreign Application Priority Data
Aug. 16, 2006 (CN) 200620077112.8

(51) Int. Cl. G03B 21/32

(52) U.S. Cl. 352/85

(57) ABSTRACT

A Digital Scent Movie Projector with Sound Channels. Its features include: A Digital Movie Projector, A sense of smell signal converter and a set of scent making devices. A digital movie projector uses a full frequency sound channel as its passageway to transmit sense of smell digital signal or adding a sense of smell digital signal transmission passageway besides the several full frequency and a low frequency sound channel. After being processed by the sense of smell signal converter the sense of smell signal is transmitted into the scent making devices. The scent making devices uses the scent transmission passageway to transmit the scent of the scent can into the pressure-reducing valve and sound muffler, with help of the air compressor and the controlling valve. And finally the scent is released into the cinema from the scent outlet devices installed under or by the audience seats. With this proposal and without any modification to a digital movie projector, the sense of smell signal can be programmed into digital movies and can be projected utilizing one of the full frequency sound channels of a digital movie projector. Therefore it enables the film arts to break the monopoly of traditional film and truly realizes the trinity enjoyable effect of sense of sight, hearing and smell.

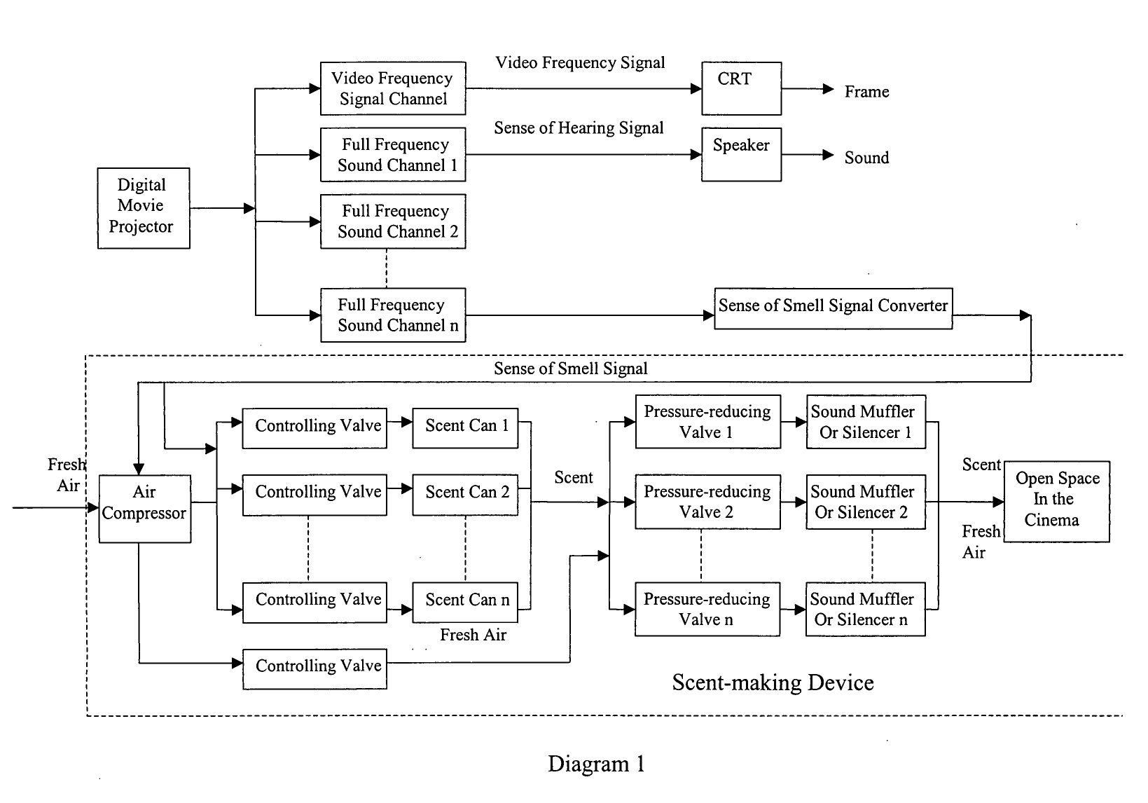

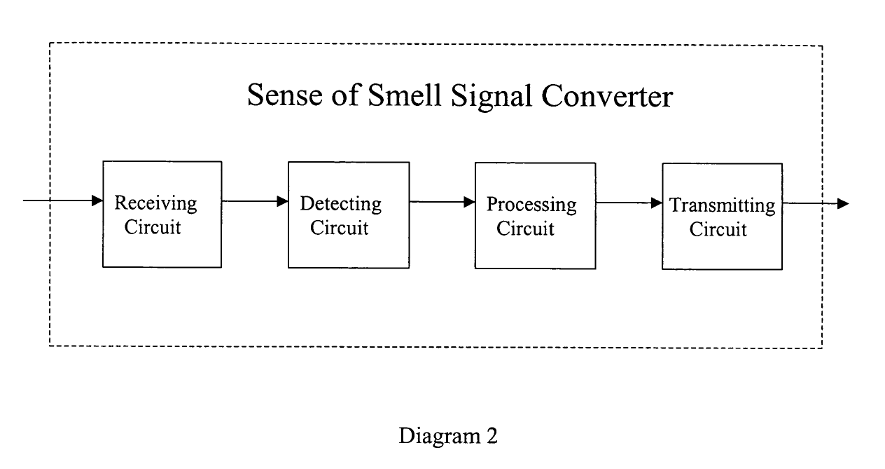

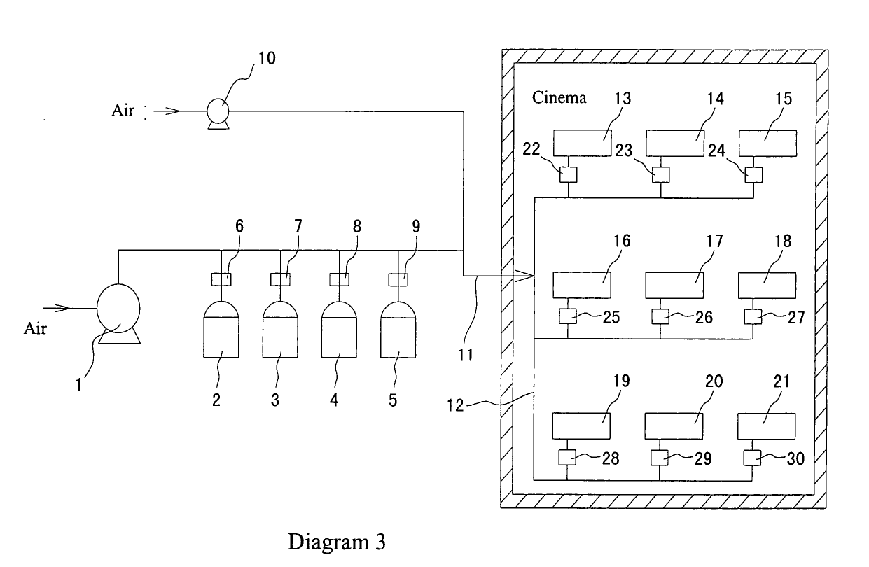

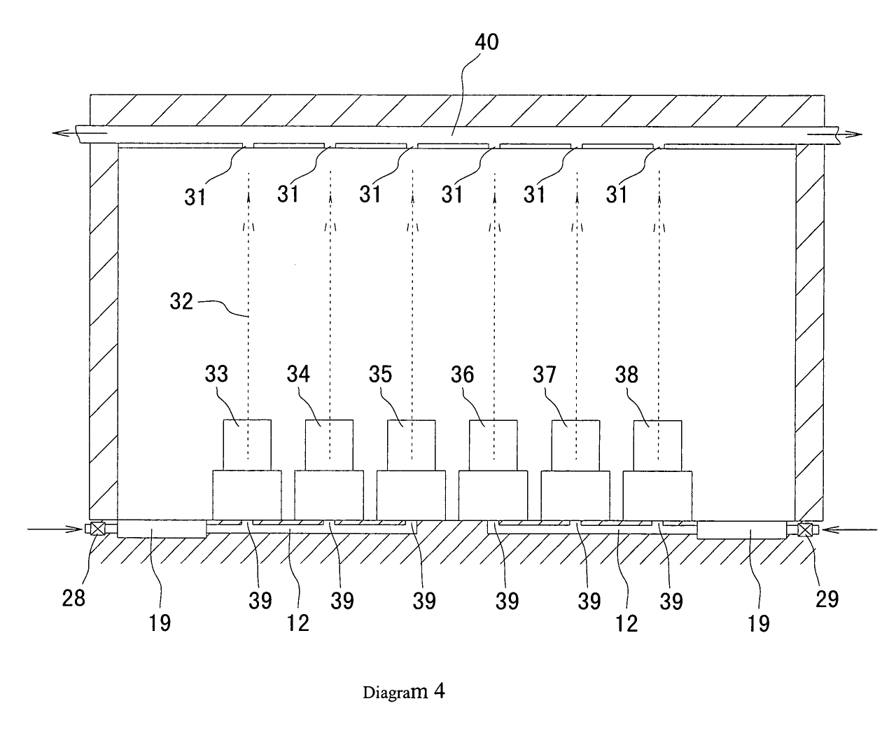

### FIELD OF THE INVENTION

The technology deals with the field of a Multiple Dimensional Digital Movie Projector, especially deals with the device which can produce the effect of sense of smell by utilizing multiple full frequency sound channels of existing digital movie projector by programming the digital process of sense of smell into a certain full frequency sound channel. It is a device of utilizing a sense of hearing and sense of smell digital signal converter to produce scent effect. Without any modification to the existing digital movie projector the device enables the film arts to break the monopoly of traditional film and truly realizes the enjoyable trinity of sense of sight, sense of hearing and sense of smell.

### BACKGROUND OF THE INVENTION

At the moment seeing movies have become an indispensable part of people's life. It not only gives pleasure but also provides large quantity of information and knowledge to the audience. The existing movie programs pay a lot of attention to the development of effect of sense of sight and hearing. But human being can acquire information by sense of touch, sense of smell and sense of taste besides by sense of sight and sense of hearing. If we restrain the function of information conveying of the movies to the sense of sight and sense of hearing, then we are limiting people to enjoy this kind of the culture and arts.

As all we know, with the existing technology film arts can only provide us with rich effect of sense of sight and sense of hearing, but it cannot provide us with effect of sense of smell. The most difficult point of it is that smell is a chemical substance and its composition is too complicated. Usually it cannot be composed with several elements. Secondly there are few sensors capable of transforming smell into electronic signals. There are no devices with smell signal recording, editing and projecting capability. Although some patents both at home and abroad suggest to use composed simulation signal with sense of sight, sense of hearing and sense of smell to make such programs, which can transmit sense of sight, sense of hearing and sense of smell signals through signal detecting and separately controlling the screen, speakers and scent-making devices. At the moment the existing movie projector is not capable of detecting and projecting the composed signals of sense of sight, sense of hearing and sense of smell. On the other hand, both at home and abroad, some patents suggest releasing some heated liquid with scent into the openness by fans or releasing them directly from “scent bottles.” by fans. All of these methods have defects: when projecting the movie the scent is not matched with the movie plot and it cannot be closely distributed to every seat. The smell disappears immediately after the smell signal stops.

### SUMMARY OF INVENTION

The technology provides a Digital Scent Movie Projector with Sound Channels. Its objective is to provide us with a high quality movie frame with sense of smell effect and enable us truly enjoy the effect of sense of sight, sense of hearing and sense of smell while providing us with modern film works with rich effect of sense of sight and hearing, and in the meantime giving us more entertainment and enjoyment.

In order to achieve above-mention objectives the technology utilizes the proposal: A Digital Scent Movie Projector with Sound Channels. It includes:

A Digital Movie Projector with several full frequency channels and a low frequency sound channel. One of its full frequency sound channels is used as a transmission passageway to transmit of sense of smell digital signal or adding an outlet passage to transmit digital signal of sense of smell besides the several full frequency channels and a low frequency sound channel. A signal converter of sense of smell includes: Receiving Circuit, Detecting Circuit, Processing Circuit and Transmission Circuit. The Projector's outlet passage of transmitting digital signal of sense of smell is connected with the inlet of Receiving circuit of the signal converter of sense of smell. The sense of smell control signals are sending out through the outlet of the Transmission Circuit after being though the Detecting Circuit, Processing Circuit and the Receiving Circuit.

A set of Scent Making Equipment includes:

A scent transmission passageway is composed of a General Scent Transmission Passageway and a group of branch scent transmission passages. The branch scent transmission passages are connected with the General Scent Transmission Passageway. Its principle is similar to the air conveying device of a central air conditioning system.

An Air Compressor is used as a power house to release the scent. The Air Compressor has an air outlet. The outlet is connected with the inlet of above mentioned General Scent Transmission Passageway

A set of control valves used as outlet switch of corresponding scent transmission. The controlling end of each valve is connected with the scent controlling signal of the scent signal converter. And the outlet of each controlling valve in connected with the General Scent Transmission Passageway through additional pipes.

A set of scent cans are used as the source of different scents. The outlet of each scent cans is connected with corresponding inlet of each controlling valves.

A set of mufflers are separately installed in the passages of the branch scent transmission. The mufflers have scent outlets. The outlets are installed by or under the audience seats in the cinema and the scent is released into the openness of the cinema.

Explanations of above-mentioned technical proposals:
1. In above-mentioned proposal, in order to effectively control the scent field in the cinema a group of air intake devices are installed in the upper space of the cinema correspondingly to the scent release outlets. The setting of air intake devices and scent outlets form a vertical scent field floating from bottom to top. And the scent is blown out of the cinema through the air intake devices with fans. Matching of the movie scent and movie plot is one of the important targets of the quality. It requires that the audience can smell the scent immediately when the movie has related plot. And when the plot is over the scent should disappear immediately. This can be realized with a vertical scent field floating from bottom to top, which is proposed by the technology.
2. In above-mentioned proposal, in order to reduce the pressure of the scent release outlet, a pressure-reducing valve is installed in each front end of the mufflers.
3. In above-mentioned proposal, in order to improve the air circulating of the cinema an air pump is installed. The outlet of the pump is connected with the General Scent Transmission Passageway through pipes. The inlet is connected with the outlet of air conditioning system or with the fresh air outside of the cinema.
4. In above-mentioned proposal, the control valves are of electromagnetic valves, Service control components, pneumatic components or hydraulic controlling components.
5. In above-mentioned proposal, the scents includes: flower, perfume, coffee, vegetable cooking, fruits, sour, pepper, foul, smell of fish, fireworks and gun powder, etc. the smell of the scent can be liquid or compressed air. When the controlling valve is released and the scent is conveyed to the general scent transmission passageway, the liquid (Aerosol spray) or gas (release quantity and pressure of the compressed air has a direct ratio) is distributed into the cinema through the general scent transmission passage and the branch scent transmission passage. Scent variety can be as many as possible. A kind of scent can be stored in one scent can as well as in several scent cans. The scent should be natural scent or synthetic scent which is harmless to human body.
6. In above-mentioned proposal, when the scent is released the scent intensity can be controlled by using different scent cans or by controlling the release time and level of the valve as to meet the requirement of the movie plot. This requirement can be programmed according to the movie plot when the movie was shooting. After the scent is released into the cinema the valves can be shut off and the air intake system can be started to absorb the scent and blow them out of the cinema before ending of a certain movie plot. In the meantime fresh air is conveyed into the cinema through the scent transmission passages, controlled by the air compressor, in order to keep the air of the cinema fresh. The air intake system can keep working all the time.
7. In above-mentioned proposal, scent muffler is made of sound-reducing and sound insulation material and is of a flat shaped case in order to be place under the audiences' seats. The function of the scent mufflers is to muffle the sound of the digital scent, remove the noise and transform it into soundless scent. Silencing of the movie scent is one of the important targets related to the quality of the movie. By utilizing the scent muffler the technology guarantees that there is no noise during the show time of the digital scent movie. Principle of the technology: in order to achieve above-mentioned proposal a sense of smell digital signal is programmed in a corresponding signal of one of the full frequency sound channels utilizing the digital movie full frequency sound channel when the digital scent movie is being shooting, or by adding a digital sense of smell signal transmission passage other than the several full frequency channels and the low frequency channel. And there is a sense of smell signal outlet end corresponding to this transmission passage. The sense of smell digital signal should be matched with the move plot. During the show time of the movie the sense of smell digital signal is conveyed to sense of smell signal converter through the full frequency sound channels of the digital movie projector. Through the receiving circuit, detecting circuit, processing circuit and the transmission circuit the sense of smell controlling signal starts the air compressor and the controlling valve, with the function of the compressed air the scent is conveyed to the general scent transmission passageway from the scent cans and finally through the branch scent transmission passages the scent is released into the cinema from the outlet end. If a group of air intake devices are installed in the upper space of the cinema then a vertical scent field floating from bottom to top is formed.

Advantages of the technology compared with existing technologies:
1. The technology combines sense of sight and hearing signal of existing movies and the sense of smell signal so that it increases the enjoyable effect of the movie.
2. When a digital movie is being shot with the technology the sense of smell digital signal is programmed in one of the full frequency sound channels by utilizing the multiple digital movie sound channels. During the show time of digital scent movies, the digital scent signal is conveyed to sense of smell signal converter from the full frequency sound channel. Therefore the digital scent movie is realized without modifying the digital movie shooting equipment and digital movie projecting equipment.
3. With the technology, scent release devices are installed under the audiences' seats and a group of air absorbing devices are installed in the upper space of the cinema so that a vertical scent field floating from bottom to top is formed. It can effectively control the forming and disappearing of various scents, guaranteeing a precisely matching of the digital scent and the movie plot.
4. The technology can be combined with vertical digital movie to form a unity of sense of sight, hearing, smell and multiple dimensional effects so that it provides the audience with more enjoyment and entrainment. Combination of the technology and vertical movie increases the comprehensive effect of the vertical movie.
5. The technology forms a unity of sense of sight, sense of hearing signal of existing technology, sense of smell signal and features of multiple dimensional movie so that it leads the development of study, production and market development of multiple function vertical movie, multiple dimensional movies of entrainment facilities and entrainment fields into a new realm.

### BRIEF DESCRIPTION OF THE DRAWINGS

Drawing 1 Principle of the technology

Drawing 2 Sense of smell signal converter frame of the technology

Drawing 3 Equipment Layout of digital scent movie cinema

Drawing 4 Scent distribution layout under audiences' seats

### DETAIL DESCRIPTION OF THE INVENTION

In above attached drawings:

1, Air Compressor; 2-5, Scent Cans; 6-9, Electro-magnetic valves 10, Air Pump 11, General Scent Transmission Passage 12. Branch Scent Transmission Passage; 13-21, Sound Mufflers 22-30, Pressure-reducing Valves; 31, Air intake, 32. Vertical Scent Field, 33-38. Audience Seats; 39. Scent Release Devices; 40, Air Intake Pipe.

Further description with attached drawings and examples:

### Example: Refer to Drawing 1.

A projecting device of Digital scent movie, composed of one set of digital movie projector, one Set of scent signal converter and one set of scent making equipment.

A set of digital movie projector with 5 full frequency sound channels and 1 low frequency sound channel. One of the full frequency sound channels is used as digital sense of smell signal transmission passageway and a sense of smell signal outlet is installed in the corresponding transmission passage.

A set of sense of smell signal converter composed of Receiving Circuit, Detecting Circuit, Processing Circuit and Transmission Circuit. Refer to Drawing 2. The processing circuit includes a CPU and corresponding converting programs. The sense of smell signal outlet of the digital movie projector is connected with the Receiving Circuit inlet of the sense of smell signal converter. The outlet of the Receiving Circuit is performed through Detecting Circuit, Processing Circuit and Transmitting Circuit and sense of smell controlling signal is released from the outlet end of the Transmission Circuit.

A set of scent making equipment, refer to drawing 3, composed of a scent transmission passage, as air compressor,

| | | | |
|---|---|---|---|
| 1 | An air pump (1) | 1 | Air Pump (10) |
| 4 | electromagnetic valves (6–9) | 4 | scent cans (2–5) |
| 9 | sound mufflers (13–21) | 9 | pressure-reducing valves |
| | | | (22–30) |

The scent transmission passage is composed of a General Scent Transmission Passageway (11) and 3 branch scent transmission passages (12)

The General Scent Transmission Passageway (11) is separately connected with 3 branch scent Transmission passages. It is similar with the air conveying system of central air conditioning. Air compressor (1) is used as the driver of scent transmission. One of the outlets of the air compressor is connected with the inlet of the general scent transmission passageway (11).

The outlet of Air pump (10) is connected with the general scent transmission passageway (11) though pipes, and its inlet is connected with the cold air duct of the air conditioning system or connected with fresh air outside of the cinema.

4 electromagnetic valves (6-9) are separately used as controlling switches of corresponding scent releasing controlling. The controlling end of each electromagnetic valve is connected with the sense of smell signal of the sense of smell signal converter; the outlet of the each electromagnetic valve is separately connected with the general scent transmission passageway (11) through ducts.

9 sub branch passages on the 3 branch scent transmission passages (12). There are 9 corresponding pressure reducing valves on the 9 sub branch passages (22-30) and 9 sound mufflers (13-21)

Each pressure reducing valve and muffler are used as a sub branch path. The mufflers have scent release end (39), as drawing 4 indicates. The scent releasing end (39) is installed under or by the audiences' seats and open to the cinema. An air intake device is installed in the upper space in the cinema (31) corresponding to the scent release end (39). A group of air intake devices (31) are installed corresponding to the scent release end (39) and form a vertical scent field floating from bottom to top (33-38). A group of air intake devices (39) are connected with outside of the cinema through air intake pipe (40) and fans.

The scent type, intensity and time control is based on the movie program, designing, scenario and sound. The sense of smell signal and the existing sense of sight and hearing signal are programmed in a digital program when the movie is shooting. The sense of smell signal is programmed in the full frequency sound channel n, n, which is the last full frequency sound channel of a digital movie projector. At the moment according to stipulations of China Broadcast and Television Bureau, the digital movie should have 5 full frequency sound channels and 1 low frequency sound channel, therefore n=5. When digital scent movie is showing, after being detected and processed by the movie projector, sense of smell signal, sense of sight signal and sense of hearing signals are transformed into sound signal A through No. 5 full frequency based on the movie plot, then they are transmitted to the scent can (2-5) and a certain corresponding electromagnetic valve (6-9) through sense of smell digital signal B which is acquired by sense of smell signal converter. Starting the electromagnetic valve the scent based on the corresponding move plot is transmitted into the general scent transmission passageway (11) through the air compressor (1), and they are further transmitted into scent sound muffler (13-21) through scent pressure-reducing valve (22-30) and then they are released to the surrounding area of the audience seats. As the scent sound mufflers (13-21) are installed under the audiences' seats the audience can immediately smell the scent required by the movie plot, like flower, perfume, coffee, vegetable cooking, fruits, sour, pepper, foul, smelling of fish, fireworks and gun powder, etc. If the air intake devices (31) are started then a vertical scent field is being formed from bottom to top.

The scent type, length of release time and intensity can be controlled by choosing different scent cans (2-5) and by controlling the start time, length of release time and intensity. All these can be programmed during the shooting of digital movie programs. Regarding above-mentioned electromagnetic valves, if there is no requirement of the scent intensity, then regular electromagnetic valves can be used. If there is a requirement of scent intensity then service electromagnetic valves should be used. The sense of smell signal is transmitted from the full frequency sound channel of the digital movie projector and forms a unity of sense of smell signal, sense of sight signal, sense of hearing signal and vertical movie and transforms them into a 4-dimensional movie system.

The sound muffler of scent movie is an important target of the quality of digital scent movie. The scent sound muffler of the technology guarantees that there is no noise during the show time of digital scent movie.

The precisely matching of movie scent and the movie frame is another import target of the quality of digital scent movie. The precisely match of the two aspects requires that the audience can immediately get the relative smell from the movie plot. And when the scent of movie plot disappears the smell should be disappeared immediately. The scent can be disappeared immediately by using the vertical scent field of the technology. Of course there should be a work process in advance. All of the electromagnetic valves should be shut off at the same time. The fresh air come out of the air compressor (1) or air pump (10) is conveyed to the scent pressure-reducing valves installed under the audiences' seats, and then further conveyed into the scent sound muffler, and finally the fresh air is released into the cinema through the scent sound muffler.

Example of the setting of sense of smell signal:

Hypothesize No. 2 scent can is Type A perfume, No 3. Scent can is Type B perfume, No. 4 scent can is jasmine scent, and No. 5 scent can is coffee scent. A scent pressure-reducing valve and a scent sound muffler are installed under each audience seat or several audience share one scent pressure-reducing valve and one scent sound muffler.

The Switch process of air compressor (1) is set by Group A digitals. The type of scent of smell signal is set by Group B digitals. Scent intensity is set by Group C digitals. The fresh air conveying air pump (10) is set by Group D digitals. The air intake system is set by Group E digitals. Following is the example of its program:

A. Setting of air compressor switch program

| | |
|---|---|
| 0000 0000 | Shut off Air Compressor 1 |
| 0000 0001 | Start Air Compressor 1 |

B. Setting of scent can electromagnetic valve program

| | |
|---|---|
| 0000 0000 | Shut off Scent Controlling Electromagnetic Valve |
| No. 2 0000 0001 | Start Electromagnetic Valve of Type A Perfume |
| | Scent Can |
| No. 3 0000 0010 | Start Electromagnetic Valve of Type B Perfume Scent Can |
| No. 4 0000 0011 | Start Electromagnetic Valve of Jasmine |
| | Scent Can |
| No. 5 0000 0100 | Start Electromagnetic Valve of Coffee Scent Can |

C. Setting of scent intensity program

| | |
|---|---|
| 0000 0000 | “NO” scent (Electromagnetic Valve end “0”) |
| 0000 0001 | “Week” scent (Electromagnetic Valve opens narrowly) |
| 0000 0010 | “Relatively strong” Scent (Electromagnetic Valve |
| | relatively wide) |
| 0000 0011 | “Strong” Scent (Electromagnetic Valve opens wide) |
| 0000 0100 | “Very Strong” Scent (Electromagnetic Valve opens |
| | very wide) |

D. Setting of fresh air conveying air pump (10) program

| | |
|---|---|
| 0000 0000 | Shut off the air pump (10) |
| 0000 0001 | Start the air pump (10) |

E. Setting of air return system program

| | |
|---|---|
| 0000 0000 | Shut off air intake system |
| 0000 0001 | Start air intake system |

For example, 20 minutes after the digital movie projector started working, 3 minutes of jasmine is shown in the movie frame, therefore the movie projector should transmit sense of smell signal to start the electromagnetic Valve of No. 4 scent can to release jasmine scent. The release time should be 3 minutes. 30 minutes later people drinking coffee for 5 minutes in the movie frame, the movie projector should transmit sense of smell signal to start the electromagnetic Valve No. 5 scent can to release coffee scent. Release time should be 5 minutes. The coffee scent is Transmitted into the sound muffler from the air compressor through scent pressure reducing valve and then is further released into the cinema. Whenever the scent releasing stops, some natural air should be released to make the air fresh. The air intake devices in the cinema should be kept in a working condition.

The comprehensive program of above-mentioned jasmine scent and coffee scent:

T1 = 0 (Minutes)

| | | |
|---|---|---|
| A. | 0000 0000 | Shut off air compressor (1) |
| B. | 0000 0000 | shut off the scent can controlling electromagnetic valve |
| C. | 0000 0000 | “NO” scent |
| D. | 0000 0000 | Shut off the fresh air conveying air pump (10) |
| E. | 0000 0000 | Shut off the air intake system |

T2 = 19.5 (minutes) (0.5 minute in advance)

| | | |
|---|---|---|
| A. | 0000 0001 | Start air compressor (1) |
| B. | 0000 0011 | Start jasmine scent electromagnetic valve (No. 4) |
| C. | 0000 0001 | “Week” scent |
| D. | 0000 0000 | Shut off the fresh air conveying air pump (10) |
| E. | 0000 0000 | Shut off the air intake system |

T3 = 22.5 (minutes) (0.5 minute in advance)

| | | |
|---|---|---|
| A. | 0000 0001 | Start air compressor (1) |
| B. | 0000 0000 | shut off the scent can controlling electromagnetic valve |
| C. | 0000 0000 | “NO” scent |
| D. | 0000 0001 | Start the fresh air conveying air pump (10) |
| E. | 0000 0001 | Start the air intake system |

T4 = 25 (minutes)

| | | |
|---|---|---|
| A. | 0000 0000 | Shut off air compressor (1) |
| B. | 0000 0000 | shut off the scent can controlling electromagnetic valve |
| C. | 0000 0000 | “NO” scent |
| D. | 0000 0000 | Shut off the fresh air conveying air pump (10) |
| E. | 0000 0000 | Shut off the air intake system |

T5 = 29.5 (minutes) (0.5 minute in advance)

| | | |
|---|---|---|
| A. | 0000 0001 | Start air compressor (1) |
| B. | 0000 0100 | Start electromagnetic valve (No. 5) of coffee scent can |
| C. | 0000 0011 | “Strong” Scent (Electromagnetic Valve opens wide) |
| D. | 0000 0000 | Shut off the fresh air conveying air pump (10) |
| E. | 0000 0000 | Shut off the air intake system |

T6 = 34.5 (minutes) (0.5 minute in advance)

| | | |
|---|---|---|
| A. | 0000 0001 | Start air compressor (1) |
| B. | 0000 0000 | Shut off electromagnetic valve of scent can |
| C. | 0000 0000 | “NO” scent |
| D. | 0000 0001 | Start the fresh air conveying air pump (10) |
| E. | 0000 0001 | Start the air intake system |

T7 = 37 (minutes)

| | | |
|---|---|---|
| A. | 0000 0000 | Shut off air compressor (1) |
| B. | 0000 0000 | shut off the scent can controlling electromagnetic valve |
| C. | 0000 0000 | “NO” scent |
| D. | 0000 0000 | Shut off the fresh air conveying air pump (10) |
| E. | 0000 0000 | Shut off the air intake system |

In above example, the scent can electromagnetic valve is started and shut off 5 minutes in advance. The fresh air conveying air pump and the air intake system is started and shut off 5 minutes in advance. Considering time lag of the system, this setting ensures the scent releases and disappears in time. But this is an estimated time. The precise lag time can be acquired by statistics through tests.

The above example explains the technical concept and uniqueness of the invention. Its objective is to let people who are familiar with the technology of this invention to materialize this project, but they are not allowed to use it to limit the scope of its protection. The scope of protection of this invention includes any modification and equivalent alteration based on the principle of this invention.

1. A Digital Scent Movie Projector with Sound Channel. Its Features include:
A Digital Movie Projector with several full frequency sound channels and a low frequency sound channel. One of its full frequency sound channels is used as an passageway to transmit digital signal of sense of smell or adding an outlet passage for transmit sense of smell digital signal besides the several full frequency channels and a low frequency sound channel and an outlet end of sense of smell digital signal is installed in the corresponding passageway.
A signal converter of sense of smell includes: Receiving Circuit, Detecting circuit, Processing Circuit and Transmitting Circuit. The Projector's outlet passageway of transmitting sense of smell digital signal is connected with the inlet of the Receiving Circuit of the sense of smell signal converter. The sense of smell control signals are sending out through the outlet of the Transmitting Circuit after being though the Detecting Circuit, Processing Circuit and the Receiving circuit.
A set of Scent Making Equipment includes: A scent transmission passageway, the passageway is composed of a General Scent Transmission passageway and a group of Branch Scent Transmission passageways. The branch scent transmission passages are connected with the General Scent Transmission passage. Its principle is similar to the air conveying device of a central air conditioning system.
An Air Compressor used as a power house to release the scent. The Air Compressor has an air outlet. The outlet is connected with the inlet of above mentioned General Scent Transmission Passage.
A set of control valves used as outlet switch of corresponding scent transmission. The controlling end of each valve is connected with the scent controlling signal of the scent signal converter. And the outlet of each controlling valve in connected with the General Scent Transmission Passage through additional passageways.
A set of scent cans are used as the source of different scents. The outlet of each scent cans is connected with corresponding inlet of each controlling valves.
A set of sound mufflers are separately installed in the passages of the branch scent transmission. The mufflers have scent outlets. The outlets are installed by or under the audience seats in the cinema and the scent is released into the openness of the cinema.

2. Based on Item 1 of Digital Scent Movie Projector with Sound Channels. Its features include:
A group of air intake devices are installed in the upper space of the cinema correspondingly to the scent release outlets. The setting of air intake devices and scent outlets form a vertical scent field floating from bottom to top. And the scent is blown out of the cinema through the air intake devices with fans.

3. Based on Item 1 of Digital Scent Movie Projector Bwith Sound Channels. Its features include:
Pressure-reducing valves are installed in the front end of each muffler's pipe.

4. Based on Item 1 of Scent Movie Projector with Digital Sound Channel. Its features include:
An Air Pump. The outlet of the pump is connected with the General Scent Transmission Passage through pipes. The inlet is connected with the outlet of air conditioning system or with the fresh air outside of the cinema.

5. Based on Item 1 of Scent Movie Projector with Digital Sound Channel. Its features include:
The above-mentioned control valves are of electromagnetic valves, Service control components, pneumatic components or hydraulic controlling components.
